(19) United States
(12) Patent Application Publication
(10) Pub. No.: US 2015/0300199 A1
(43) Pub. Date: Oct. 22, 2015

(54) TURBOFAN WITH OPTICAL DIAGNOSTIC CAPABILITIES

(71) Applicant: UNITED TECHNOLOGIES CORPORATION, Hartford, CT (US)

(72) Inventors: William E. Rosenkrans, Columbia, CT (US); Frederick M. Schwarz, Glastonbury, CT (US)

(21) Appl. No.: 14/647,857

(22) PCT Filed: Nov. 25, 2013
(86) PCT No.: PCT/US2013/071601

§ 371 Date: May 28, 2015

Related U.S. Application Data
(60) Provisional application No. 61/730,609, filed on Nov. 28, 2012.

(51) Int. Cl. F01D 21/00; H04N 5/225; H04N 7/18; F01D 5/12; F01D 5/02

(52) U.S. Cl. CPC F01D 21/003; F01D 5/12; F01D 5/02; H04N 7/183; H04N 5/2256; F05D 2260/80; F05D 2220/36; H04N 2005/2255

(57) ABSTRACT

A system for diagnosing a rotating airfoil has an image capture device and a light emitting device. A control is programmed to actuate at least one of the image capture device and the light at a particular time to capture an image of a rotating airfoil being monitored, and then compare the captured image to an expected image. A method of diagnosing damage to a rotating airfoil is also disclosed.

### BACKGROUND

This application relates to a diagnostics system and a method incorporated into a gas turbine engine.

Gas turbine engines are known and, typically, include a fan delivering air both as bypass air for propulsion and into a compressor. The compressor section includes rotors which rotate to compress air and deliver it into a combustor. The air is mixed with fuel and ignited in the combustor and products of the combustion pass downstream over turbine rotors, driving them to rotate.

There are any number of challenges to gas turbine engines when utilized in an aircraft. As an example, birds may impact and damage the fan blades. In addition, solid elements, such as rocks, may be ingested by the fan into the engine and can damage the compressor rotors.

Historically, the fan has rotated at one speed with a compressor rotor. This limited the size of the fan for several reasons. More recently, it has been proposed to incorporate a gear reduction between the fan rotor and the compressor rotor.

With this change, the diameter of the fan rotor has increased dramatically and the speed of the fan rotor has decreased. This raises challenges with regard to the damage events mentioned above.

As the fan diameter has increased, the potential for bird strikes also increases. Further, as the fan speed decreases, the likelihood of rocks or other large items passing beyond the fan rotor and impacting the compressor rotor also increases.

Should any of the damage events mentioned above occur, it would be desirable to quickly identify the damage, such that maintenance or other proactive steps can be initiated. Various types of diagnostic systems have been proposed, but have generally been related to the used of vibration detection.

Image recognition software is known and has been utilized in any number of applications. As an example, image recognition software has been proposed for use in identifying structural cracks after earthquakes.

### SUMMARY

In a featured embodiment, a system for diagnosing a rotating airfoil has an image capture device and a light emitting device. A control is programmed to actuate at least one of the image capture device and the light at a particular time to capture an image of a rotating airfoil being monitored, and then compare the captured image to an expected image.

In another embodiment according to the previous embodiment, the system is provided with a strobe light as the light. The strobe light is actuated in a timed manner to capture the image of the airfoil.

In another embodiment according to any of the previous embodiments, the image capture device is a camera provided with a digital shutter timed to capture the image of the airfoil.

In another embodiment according to any of the previous embodiments, the control also compares an expected time of arrival of a leading edge of the rotating airfoil to the actual time of arrival.

In another embodiment according to any of the previous embodiments, the control identifies cracks on the rotating airfoil utilizing the captured image.

In another embodiment according to any of the previous embodiments, the size of an expected crack is compared to prior captured image over time to identify a growth of a crack.

In another embodiment according to any of the previous embodiments, the image capture device and the light are mounted on an aircraft and capture the images during flight operation.

In another embodiment according to any of the previous embodiments, the rotating airfoil is part of a gas turbine engine.

In another embodiment according to any of the previous embodiments, the system is utilized with at least one of a rotating fan blade, a first stage of a low pressure compressor and a first stage of a high pressure compressor.

In another embodiment according to any of the previous embodiments, the system is associated with each of the fan blades and the low and high pressure compressor first stage rotors.

In another embodiment according to any of the previous embodiments, a gear reduction is placed between the fan rotor and the low pressure compressor rotor.

In another embodiment according to any of the previous embodiments, the captured image is of a leading edge of the rotating airfoil.

In another embodiment according to any of the previous embodiments, an air curtain is passed along the image capture device to clean the image capture device.

In another embodiment according to any of the previous embodiments, protective glass is positioned between the image capture device and the rotating blade.

In another embodiment according to any of the previous embodiments, the rotating airfoil is a propeller in a turboprop engine.

In another embodiment according to any of the previous embodiments, the rotating airfoil is a propeller on a helicopter.

In another embodiment according to any of the previous embodiments, the rotating airfoil is part of a lift fan.

In another featured embodiment, a method of diagnosing damage to a rotating airfoil includes the steps of illuminating a rotating blade at a controlled time and capturing a digital image of the illuminated leading edge, and comparing the captured image of the rotating blade to an expected image, and utilizing image recognition software to identify defects in the rotating blade.

In another embodiment according to the previous embodiment, the system is provided with a strobe light as the light. The strobe light is actuated in a timed manner to capture the leading edges.

In another embodiment according to any of the previous embodiments, the image capture device is a camera provided with a digital shutter timed to capture the rotating blade at an expected time.

In another embodiment according to any of the previous embodiments, the image capture device and the light are mounted within an aircraft and capture images during flight operation.

In another embodiment according to any of the previous embodiments, the rotating airfoil is part of a gas turbine engine.

In another embodiment according to any of the previous embodiments, the rotating blade is at least one of a rotating fan blade, a first stage of a low pressure compressor and a first stage of a high pressure compressor.

In another embodiment according to any of the previous embodiments, the rotating blade includes each of the rotating fan blade, the first stage of a low pressure compressor, and the first stage of a high pressure compressor.

In another embodiment according to any of the previous embodiments, the captured image of the rotating blade is of a leading edge of the rotating blade.

In another embodiment according to any of the previous embodiments, the rotating airfoil is a propeller in a turboprop engine.

In another embodiment according to any of the previous embodiments, the rotating airfoil is a propeller on a helicopter.

In another embodiment according to any of the previous embodiments, the rotating airfoil is part of a lift fan.

These and other features may be best understood from the following drawings and specification.

### BRIEF DESCRIPTION OF THE DRAWINGS

FIG. 1 schematically shows a gas turbine engine.

FIG. 2 schematically shows details of a portion of a gas turbine engine.

FIG. 3A shows damage to a fan blade.

FIG. 3B shows another view of the damaged blades.

FIG. 4A shows a diagnostic system for identifying damage.

FIG. 4B shows optional features.

FIG. 5 shows another embodiment.

### DETAILED DESCRIPTION

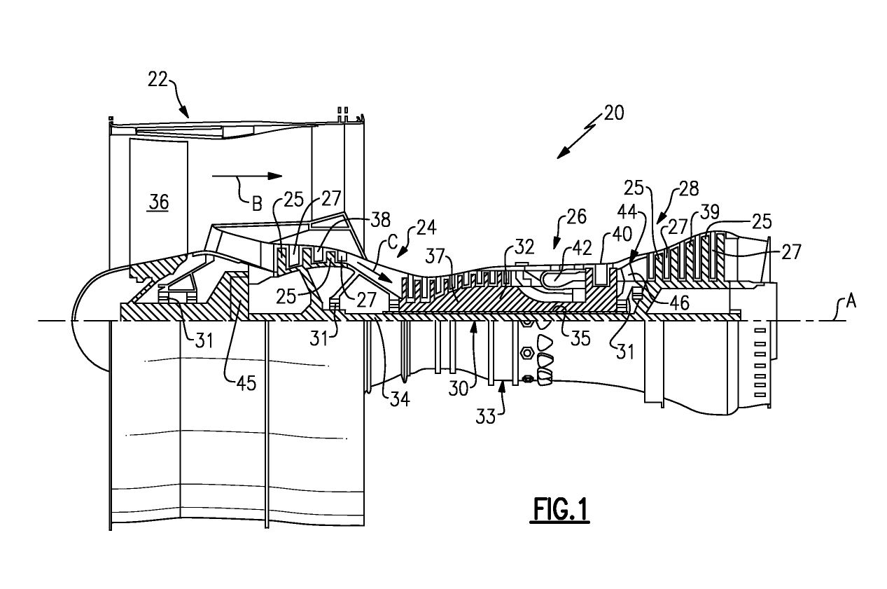

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. Alternative engines might include an augmentor section (not shown) among other systems or features. The fan section 22 drives air along a bypass flow path B in a bypass duct defined within a nacelle 15, while the compressor section 24 drives air along a core flow path C for compression and communication into the combustor section 26 then expansion through the turbine section 28. Although depicted as a two-spool turbofan gas turbine engine in the disclosed non-limiting embodiment, it should be understood that the concepts described herein are not limited to use with two-spool turbofans as the teachings may be applied to other types of turbine engines including three-spool architectures.

The exemplary engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided, and the location of bearing systems 38 may be varied as appropriate to the application.

The low speed spool 30 generally includes an inner shaft 40 that interconnects a fan 42, a low pressure compressor 44 and a low pressure turbine 46. The inner shaft 40 is connected to the fan 42 through a speed change mechanism, which in exemplary gas turbine engine 20 is illustrated as a geared architecture 48 to drive the fan 42 at a lower speed than the low speed spool 30. The high speed spool 32 includes an outer shaft 50 that interconnects a high pressure compressor 52 and high pressure turbine 54. A combustor 56 is arranged in exemplary gas turbine 20 between the high pressure compressor 52 and the high pressure turbine 54. A mid-turbine frame 57 of the engine static structure 36 is arranged generally between the high pressure turbine 54 and the low pressure turbine 46. The mid-turbine frame 57 further supports bearing systems 38 in the turbine section 28. The inner shaft 40 and the outer shaft 50 are concentric and rotate via bearing systems 38 about the engine central longitudinal axis A which is collinear with their longitudinal axes.

The core airflow is compressed by the low pressure compressor 44 then the high pressure compressor 52, mixed and burned with fuel in the combustor 56, then expanded over the high pressure turbine 54 and low pressure turbine 46. The mid-turbine frame 57 includes airfoils 59 which are in the core airflow path C. The turbines 46, 54 rotationally drive the respective low speed spool 30 and high speed spool 32 in response to the expansion. It will be appreciated that each of the positions of the fan section 22, compressor section 24, combustor section 26, turbine section 28, and fan drive gear system 48 may be varied. For example, gear system 48 may be located aft of combustor section 26 or even aft of turbine section 28, and fan section 22 may be positioned forward or aft of the location of gear system 48.

The engine 20 in one example is a high-bypass geared aircraft engine. In a further example, the engine 20 bypass ratio is greater than about six (6), with an example embodiment being greater than about ten (10), the geared architecture 48 is an epicyclic gear train, such as a planetary gear system or other gear system, with a gear reduction ratio of greater than about 2.3 and the low pressure turbine 46 has a pressure ratio that is greater than about five. In one disclosed embodiment, the engine 20 bypass ratio is greater than about ten (10:1), the fan diameter is significantly larger than that of the low pressure compressor 44, and the low pressure turbine 46 has a pressure ratio that is greater than about five 5:1. Low pressure turbine 46 pressure ratio is pressure measured prior to inlet of low pressure turbine 46 as related to the pressure at the outlet of the low pressure turbine 46 prior to an exhaust nozzle. The geared architecture 48 may be an epicycle gear train, such as a planetary gear system or other gear system, with a gear reduction ratio of greater than about 2.3:1. It should be understood, however, that the above parameters are only exemplary of one embodiment of a geared architecture engine and that the present invention is applicable to other gas turbine engines including direct drive turbofans.

A significant amount of thrust is provided by the bypass flow B due to the high bypass ratio. The fan section 22 of the engine 20 is designed for a particular flight condition—typically cruise at about 0.8 Mach and about 35,000 feet. The flight condition of 0.8 Mach and 35,000 ft, with the engine at its best fuel consumption—also known as “bucket cruise Thrust Specific Fuel Consumption (‘TSFC’)”—is the industry standard parameter of lbm of fuel being burned divided by lbf of thrust the engine produces at that minimum point. “Low fan pressure ratio” is the pressure ratio across the fan blade alone, without a Fan Exit Guide Vane (“FEGV”) system. The low fan pressure ratio as disclosed herein according to one non-limiting embodiment is less than about 1.45. “Low corrected fan tip speed” is the actual fan tip speed in ft/sec divided by an industry standard temperature correction of [(Tram° R)/(518.7° R)]^{0.5}. The “Low corrected fan tip speed” as disclosed herein according to one non-limiting embodiment is less than about 1150 ft/second.

FIG. 2 shows an example engine 100 which may be generally constructed as engine 10. An outer nacelle 101 surrounds a large fan blade 102. Downstream, a low pressure compressor first stage 104 and a high pressure compressor first stage 106 are spaced further inwardly.

A camera system 108 may communicate with a computer control 110 for analyzing the health of the fan 102, as described below.

An optic fiber 112 may be positioned to transmit images of the health of the compressor first stage 104 to a camera system 114 and communicates with a computer control 115. Similarly, an optic fiber 116 may monitor the health of the first stage high pressure rotor 106. The optical fiber 116 is shown communicating with a camera system 118 for capturing images and communicating with the computer control 119. In this embodiment, the optical fibers 112 and 116 allow the camera systems 114/118 and controls 115/119 to be positioned within a core housing 103 and, thus, better protected. In practice, the controls 110/115/119 may be combined as a single control. The image capture and analysis described below occurs during flight and other operation of the engine.

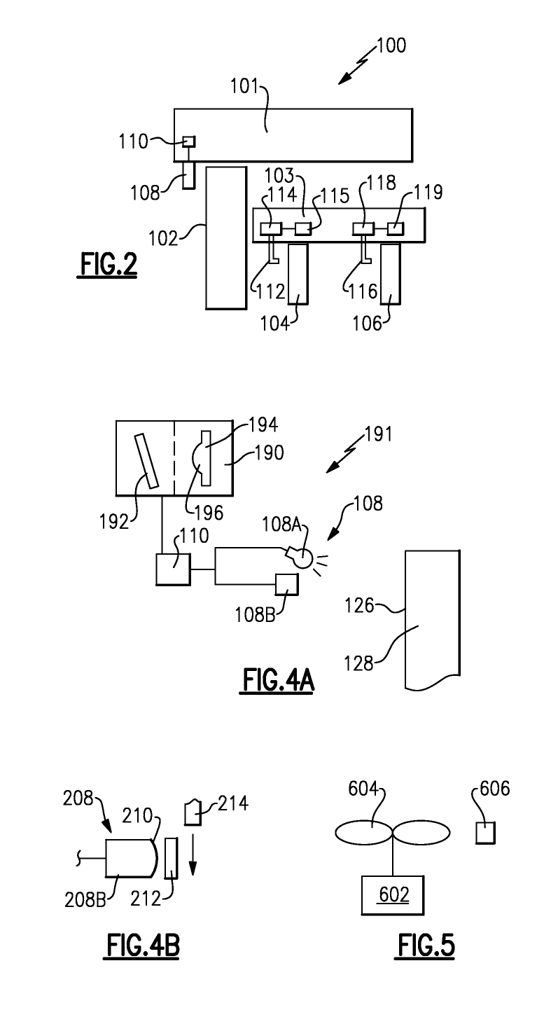

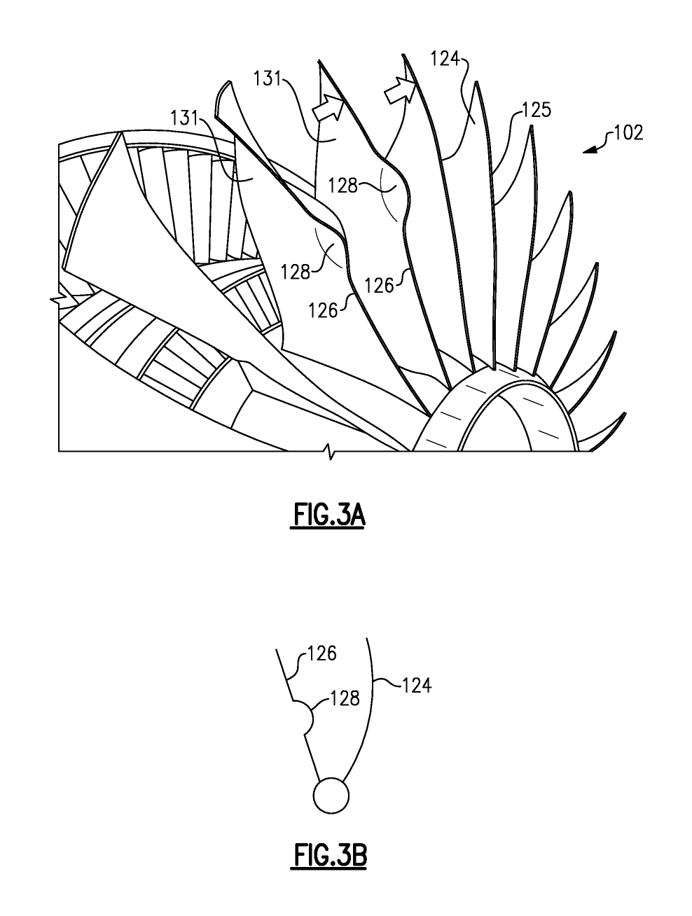

FIG. 3A shows one type of damage that can occur to a fan 102. As shown, there are a plurality of blades spaced circumferentially. A first blade 125 is shown to be undamaged and to have a predictable and smooth curve on a leading edge 124. The leading edge 126 of adjacent blades 131 are shown to have a damaged portion 128. This may be caused by a bird strike or a strike by some other item. As shown, the damaged area 128 includes a bend such that the leading edge 126 is no longer smooth. FIG. 3B more dramatically shows the bend schematically.

FIG. 4A shows a system 191 which will monitor the blade leading edges 124 and 126. It should be understood that a similar system would be utilized with the first stage rotors 104 and 106. As shown, the camera 108 system actually includes a camera 108B for capturing an image and a light 108A. The light 108A may be a strobe timed to flash each revolution or even uniformly synced to each blade's passing to capture the image of the leading edge 126/125 of each of the plurality of rotating fan blades 124/131. Alternatively, a digital shutter on the camera 108B may be so timed. The control 110 is programmed to provide images of the blade periodically, such that the leading edge of each of the blades is monitored during operation of the engine.

A visual display 190, such as a computer display, is shown including an image 192 of an expected leading edge 126 and an image 194 of the actual leading edge having the damaged area 196. The damaged area 196 shows clearly as a “glint” to image recognition software programmed into the computer control 110. Computer control 110 can be programmed to identify damage, such as the bird strike damage 128. Alternatively, digital data about the glint , such as angle of small segments of the glint along the leading edge can be programmed and changes noted for either a safe shutdown of the engine or a maintenance message can be sent requesting on-wing blending of the defect if it is digitally determined to be small.

Further, the software may be programmed to identify the actual time of arrival of any of the leading edges compared to an expected time of arrival. This would also be indicative of large-scale potential damage such as a crack in the root attachment or even the disk lugs. Further, the software may be programmed to identify cracks in most areas of the airfoil. Over time, such software can identify an increase in the size of the cracks and an increase in the departure of the arrival time from the expected arrival time. All of this information can be utilized to schedule maintenance or even shut down of the engine depending on the severity of the damage.

The glint will typically have a role and there may be other readily profiled areas with a baseline geometry stored in the system and possibly some adjustments to the baseline geometry to adjust for engine acceleration, deceleration, altitude and power. Staying with the glint for example, it has a certain time of arrival relative to a reference feature that is freezing the blade in one position. A maintenance flag is set if the line of the glint, along one small section of the blade deviates from the line of the glint elsewhere. In another example, the system may call for an in-flight shutdown if large sections of the glint were distorted relative to other parts of the blade or if the entire glint arrived late, indicating that the entire blade was coming loose due to some major attachment area distress.

FIG. 4B shows an alternative camera system 208. The cameras 208B have a curved forward face 210. Protective glass 212 may be positioned to protect the camera 208B. Further, as a second alternative, an air curtain 214 may be created to clean the glass 212 or the forward face 210 of the camera should glass 212 not be utilized.

FIG. 5 shows alternative embodiments 600. In alternative embodiments 600, the system for diagnosing a rotating airfoil 606 is associated with something other than internal rotors within a gas turbine engine. As an example, the system 602 could be a helicopter, a turboprop engine, or even an F-135 lift fan. In such systems, the rotating airfoil 604 could be the propeller, and any propeller location on a helicopter, or could be the F-135 lift fan. A vertical flight segment has a chance of bird strike, or other system failure, and thus the application of the system 606 to such locations provides valuable benefits.

Image recognition software is known and commercially available. An appropriate program can be tailored to achieve the goals of this disclosure utilizing only the commercially available software.

Although an embodiment of this invention has been disclosed, a worker of ordinary skill in this art would recognize that certain modifications would come within the scope of this disclosure. For that reason, the following claims should be studied to determine the true scope and content of this disclosure.

1. A system for diagnosing a rotating airfoil comprising:
an image capture device and a light emitting device; and
a control, said control being programmed to actuate at least one of said image capture device and said light at a particular time to capture an image of a rotating airfoil being monitored, and then compare said captured image to an expected image

2. The system as set forth in claim 1, wherein said system is provided with a strobe light as said light, and said strobe light being actuated in a timed manner to capture the image of the airfoil.

3. The system as set forth in claim 1, wherein said image capture device is a camera provided with a digital shutter timed to capture the image of the airfoil.

4. The system as set forth in claim 1, wherein said control also compares an expected time of arrival of a leading edge of the rotating airfoil to the actual time of arrival.

5. The system as set forth in claim 1, wherein said control identifying cracks on the rotating airfoil utilizing the captured image.

6. The system as set forth in claim 5, wherein the size of an expected crack is compared to prior captured image over time to identify a growth of a crack.

7. The system as set forth in claim 1, wherein said image capture device and said light are mounted on an aircraft and capture the images during flight operation.

8. The system as set forth in claim 1, wherein the rotating airfoil is part of a gas turbine engine.

9. The system as set forth in claim 8, wherein said system is utilized with at least one of a rotating fan blade, a first stage of a low pressure compressor and a first stage of a high pressure compressor.

10. The system as set forth in claim 9, wherein said system is associated with each of said fan blades and said low and high pressure compressor first stage rotors.

11. The system as set forth in claim 10, wherein a gear reduction is placed between said fan rotor and said low pressure compressor rotor.

12. The system as set forth in claim 1, wherein said captured image is of a leading edge of said rotating airfoil.

13. The system as set forth in claim 1, wherein an air curtain is passed along said image capture device to clean said image capture device.

14. The system as set forth in claim 1, wherein protective glass is positioned between said image capture device and said rotating blade.

15. The system as set forth in claim 1, wherein said rotating airfoil is a propeller in a turboprop engine.

16. The system as set forth in claim 1, wherein said rotating airfoil is a propeller on a helicopter.

17. The system as set forth in claim 1, wherein said rotating airfoil is part of a lift fan.

18. A method of diagnosing damage to a rotating airfoil comprising the steps of:
(a) illuminating a rotating blade at a controlled time and capturing a digital image of the illuminated leading edge;
(b) comparing said captured image of said rotating blade to an expected image, and utilizing image recognition software to identify defects in said rotating blade.

19. The method as set forth in claim 18, wherein said system is provided with a strobe light as said light, and said strobe light being actuated in a timed manner to capture the leading edges.

20. The method as set forth in claim 18, wherein said image capture device is a camera provided with a digital shutter timed to capture the rotating blade at an expected time.

21. The method as set forth in claim 18, wherein said image capture device and said light are mounted within an aircraft and capture images during flight operation.

22. The method as set forth in claim 18, wherein said rotating airfoil is part of a gas turbine engine.

23. The method as set forth in claim 22, wherein said rotating blade is at least one of a rotating fan blade, a first stage of a low pressure compressor and a first stage of a high pressure compressor.

24. The method as set forth in claim 23, wherein said rotating blade includes each of said rotating fan blade, said first stage of a low pressure compressor, and said first stage of a high pressure compressor.

25. The method as set forth in claim 18, wherein said captured image of said rotating blade is of a leading edge of said rotating blade.

26. The method as set forth in claim 18, wherein said rotating airfoil is a propeller in a turboprop engine.

27. The method as set forth in claim 18, wherein said rotating airfoil is a propeller on a helicopter.

28. The system as set forth in claim 18, wherein said rotating airfoil is part of a lift fan.
